(19) United States
(12) Patent Application Publication
(10) Pub. No.: US 2025/0159517 A1
(43) Pub. Date: May 15, 2025

(54) MEASUREMENT REPORT PAYLOAD REDUCTION

(71) Applicant: QUALCOMM Incorporated, San Diego, CA (US)

(72) Inventors: Hua WANG, Basking Ridge, NJ (US); Jelena DAMNJANOVIC, Del Mar, CA (US); Tao LUO, San Diego, CA (US)

(21) Appl. No.: 18/510,517

(22) Filed: Nov. 15, 2023

(51) Int. Cl. H04W 24/10; H04W 56/00

(52) U.S. Cl. CPC H04W 24/10; H04W 56/001

(57) ABSTRACT

Apparatus, methods, and computer program products for wireless communication are provided. An example method may include measuring a set of RSs for a set of cells. The example method may further include transmitting a measurement report to a network node, the measurement report including a set of entries where each entry in the set of entries corresponds to a particular combination of one particular RS in the set of RSs and one particular cell of the set of cells.

### TECHNICAL FIELD

The present disclosure relates generally to communication systems, and more particularly, to a wireless communication system with a measurement report from a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to measure a set of reference signals (RSs) for a set of cells. Based at least in part on information stored in the at least one memory, the at least one processor, individually or in any combination, is configured to transmit a measurement report to a network node, the measurement report including a set of entries where each entry in the set of entries corresponds to a particular combination of one particular RS in the set of RSs and one particular cell of the set of cells.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit a set of RSs for a set of cells. Based at least in part on information stored in the at least one memory, the at least one processor, individually or in any combination, is configured to receive a measurement report, the measurement report including a set of entries where each entry in the set of entries corresponds to a particular combination of one particular RS in the set of RSs and one particular cell of the set of cells.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating example beam management, in accordance with various aspects of the present disclosure.

FIG. 4B is a diagram illustrating example inter-cell beam management, in accordance with various aspects of the present disclosure.

FIG. 5 is a diagram illustrating example cell configuration, in accordance with various aspects of the present disclosure.

FIG. 6 is a diagram illustrating example communications between a network entity and a UE, in accordance with various aspects of the present disclosure.

FIG. 7 is a diagram illustrating example communications between a network entity and a UE for lower-layer triggered mobility (LTM), in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a diagram illustrating an example of a hardware implementation for an example apparatus and/or UE, in accordance with various aspects of the present disclosure.

FIG. 11 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects provided herein may enable use combinations to encode the cell selection and use combinations to encode the reported reference signal index for each reported cell so that the size of the measurement report may be reduced, reducing signaling overhead in the wireless communication system and improving overall efficiency.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (NB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

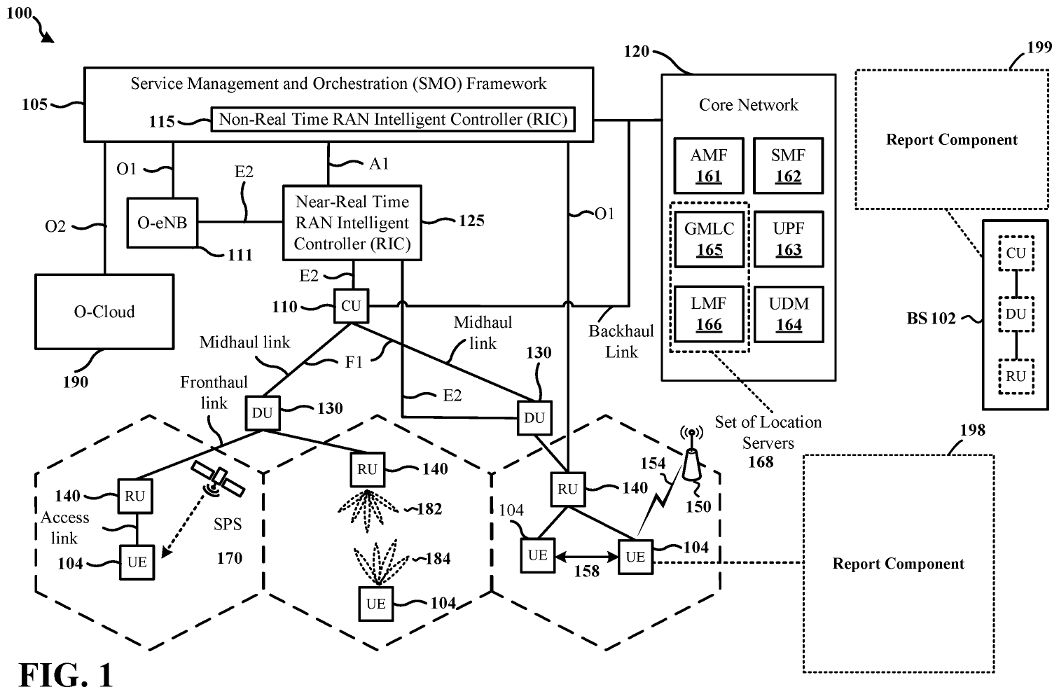

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a report component 198. In some aspects, the report component 198 may be configured to measure a set of RSs for a set of cells. In some aspects, the report component 198 may be further configured to transmit a measurement report to a network node, the measurement report including a set of entries where each entry in the set of entries corresponds to a particular combination of one particular RS in the set of RSs and one particular cell of the set of cells.

In certain aspects, the base station 102 may include a report component 199. In some aspects, the report component 199 may be configured to transmit a set of RSs for a set of cells. In some aspects, the report component 199 may be further configured to receive a measurement report, the measurement report including a set of entries where each entry in the set of entries corresponds to a particular combination of one particular RS in the set of RSs and one particular cell of the set of cells.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

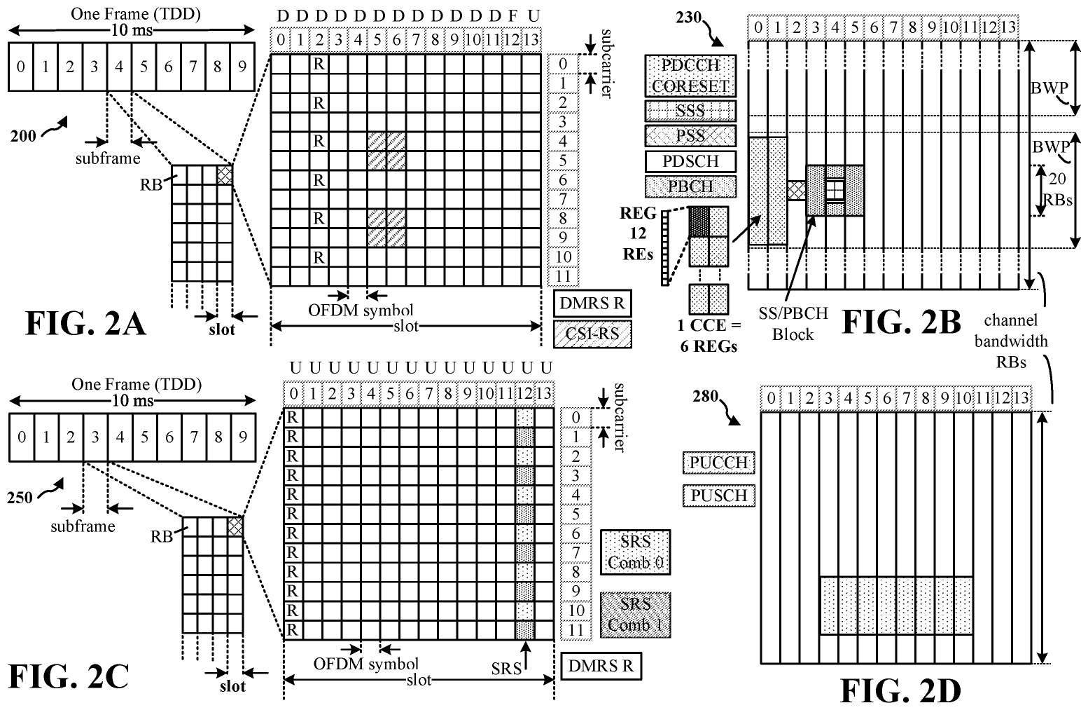

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

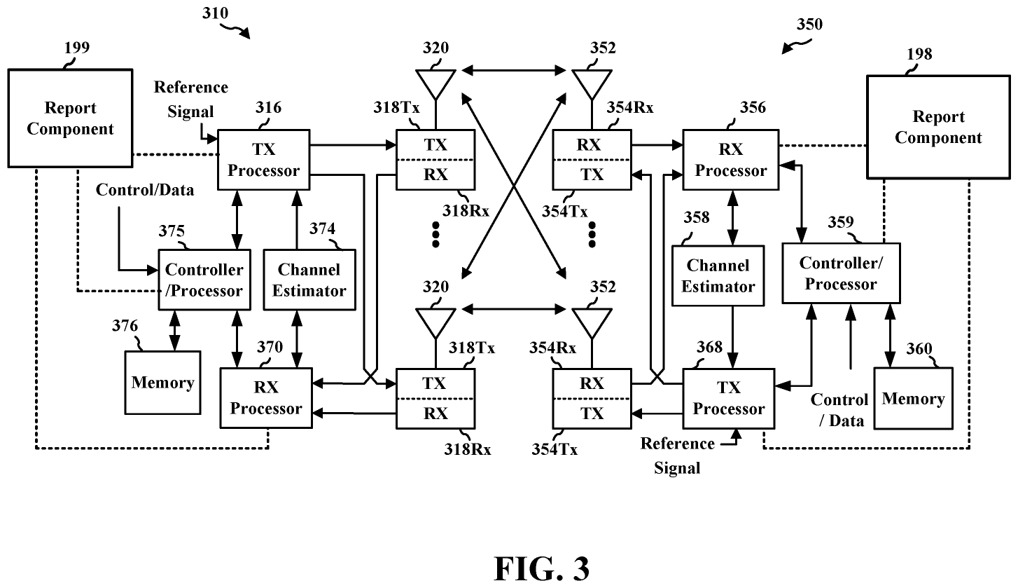

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with report component 198 of FIG. 1.

At least one of the TX processor 316, the RX processor 370, and the controller/processor 375 may be configured to perform aspects in connection with report component 199 of FIG. 1.

As used herein, the term “measurement report” refers to a signaling from a UE to a network entity to report information related to measured metric(s) associated with particular RS(s) that may be associated with particular cell(s). The metrics may include reference signal received power (RSRP), received signal strength indicator (RSSI), signal to interference and noise ratio (SINR), reference signal received quality (RSRQ) or other metrics.

The information being reported in a measurement report may include one or more best performing RSs for one or more cells, specific values of the metrics which may be represented in actual values or differential values relative to a base value, an index associated with the particular RS(s) that may be associated with particular cell(s) (such as an index of each particular combination of RS and cell), or the like. A single measurement report may be split into different signaling, and each portion of the measurement in a respective signaling may be referred to as a “segment” of the measurement report. For example, if the payload size associated with a measurement report is larger than a threshold, the UE may split the measurement into two segments and report each segment in respective uplink control information (UCI). In some aspects, the term “combination of RS and cell” may refer to a combination of RS and cell that may be represented by an “entry” of a measurement report, which may be one or more bits. For example, for a first cell associated with a first RS, a second RS, and a third RS, a measurement report may include three different combinations of RS and cell for the first cell and the three RSs, including a first combination of the first cell and the first RS, a second combination of the first cell and the second RS, and a third combination of the first cell and the third RS. As an example, the RSs may be SSBs where each SSB may correspond to a respective beam.

A network may be in communication with a UE based on one or more beams (spatial filters). For example, a network entity of the network may transmit a beamformed signal to a UE in one or more directions that correspond with one or more beams, e.g., one or more transmit beams. The UE may use a receive beam at the UE to receive the beamformed signal. Similarly, a UE may transmit a beamformed signal using one or more transmit beams, and the network entity may receive the beamformed signal using a receive beam. The network entity and the UE may perform beam training to determine the best receive and transmit directions for the network entity and the UE.

In response to different conditions, beams (e.g., a transmit and/or receive beam) may be switched. For example, a network entity may transmit an indication of a transmission configuration indication (TCI) state change to a UE so that the UE may switch to a new beam based on the indicated TCI state. The TCI state change may cause the UE to find the best UE receive beam (e.g., update the UE receive beam) corresponding to the TCI state from the network entity, and switch to such a receive beam. Switching beams may improve the connection between the UE and the network entity by ensuring that the transmitter and receiver use the same configured set of beams for communication. A TCI state may include quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The network entity may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

As another example, a spatial relation change, such as a spatial relation update, may trigger the UE to switch beams. Beamforming may be applied to uplink channels, such as but not limited to PUCCH. Beamforming may be based on configuring one or more spatial relations between the uplink and downlink signals. Spatial relation may indicate that a UE may transmit the uplink signal using the same beam as it used for receiving the corresponding downlink signal.

As another example, a network entity may change a pathloss reference signal configuration that the UE uses to determine power control for uplink transmissions, such as SRS, PUCCH, and/or PUSCH. In response to the change in the pathloss reference signal, the UE 402 may switch to a new beam.

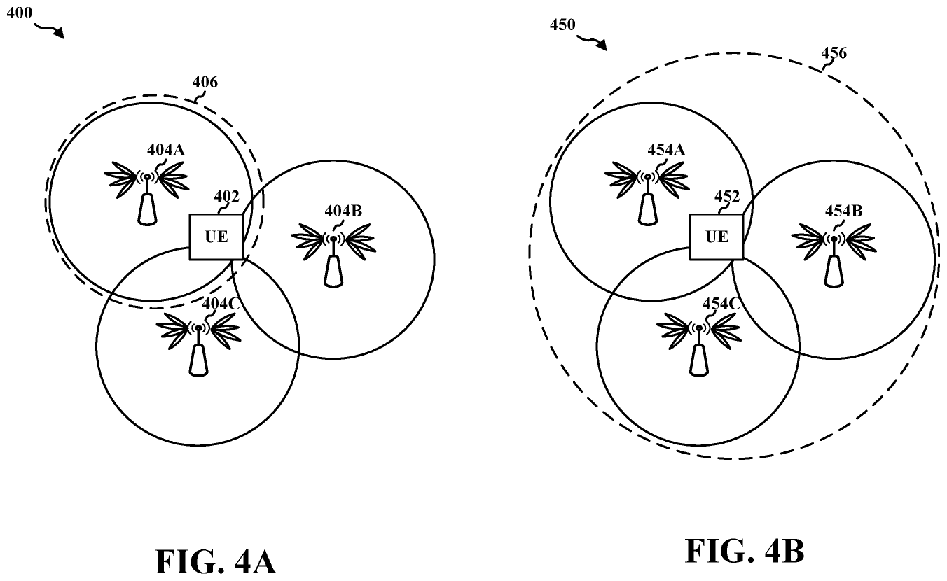

Different procedures for managing and controlling beam may be collectively referred to as “beam management.” The process of selecting a beam to switch to for data channels or control channels may be referred to as “beam selection.” In some wireless communication systems, beam selection for data channels or control channels may be limited to beams within a same physical cell identifier (ID) (PCI). A PCI may be associated with a TRP. FIG. 4A is a diagram 400 illustrating example beam management. As illustrated in FIG. 4A, for a UE 402, beam selection 406 may be limited to beams within the PCI 404A and beams associated with the PCI 404B and the PCI 404C may not be used. As an example, each of the PCI 404A, the PCI 404B, and the PCI 404C may be associated with a different TRP.

By way of example, a UE may encounter different types of mobility-cell-level mobility and beam-level mobility (which may be beam-based mobility). For cell-level mobility, a UE may experience an inter-network node handover from a current cell serving the UE to a new cell that will serve the UE. For example, as a UE moves away from the current cell and toward the new cell, the new cell may provide improved service for the UE. In some wireless communication systems, for beam-level mobility, as previously explained, switching of beams may occur within a same network node. For example, as the UE moves or changes position, a different transmit and/or receive beam may enable the UE to transmit and receive communication more effectively with the network.

In some wireless communication systems, inter-cell beam management may be based on beam-based mobility where the indicated beam may be from a TRP with different PCI with regard to the serving cell. Benefits of inter-cell beam management based on beam-based mobility may include more robustness against blocking, more opportunities for higher rank for subscriber data management (SDM) across different cells, and in general more efficient communication between a UE and the network. FIG. 4B is a diagram 450 illustrating example inter-cell beam management. As illustrated in FIG. 4B, for a UE 452, beam selection 456 may be based on beams within the PCI 454A and beams associated with the PCI 454B and the PCI 454C. As an example, each of the PCI 454A, the PCI 454B, and the PCI 454C may be associated with a different TRP.

As an example, inter-cell beam management based on beam-based mobility may be facilitated by L1 and/or L2 signaling such as UE-dedicated channels/RSs which may be associated with a switch to a TRP with different PCI according to downlink control information (DCI) or medium access control (MAC) control element (MAC-CE) based unified TCI update. As used herein, such mobility may be referred to as L1/L2 triggered mobility or lower layer triggered mobility. In some wireless communication systems PCell change using L1/L2 signaling is not supported. A UE may be in the coverage of the serving cell when communicating with TRP with different PCI (no support for a serving cell change).

In some aspects, the network may configure a set of cells for LTM. The set of cells for LTM may be referred to as LTM configured cell set. The LTM configured cell set may include an LTM activated cell set (which may also be referred to as a L1/L2 activated mobility cell set) and an LTM deactivated cell set (which may also be referred to as a deactivated LTM cell set). The LTM activated cell set may be a group of cells in the LTM configured cell set that are activated and may be readily used for data and control transfer. The LTM deactivated cell set (which may be an LTM candidate cell set) may be a group of cells in the configured set that are configured for the UE yet deactivated and may be activated by L1/L2 signaling. Once activated, a deactivated cell may be used for data and control transfer.

For mobility management of the activated cell set, L1/L2 signaling may be used to activate/deactivate cells in the LTM configured cell set and to select beams within the activated cells (of the activated cell set). As the UE moves, cells from the LTM configured cell set may be deactivated and activated by L1/L2 signaling based on signal quality (e.g., based on measurements), loading, or the like. Example measurements may include cell coverage measurements represented by Radio Signal Received Power (RSRP), and quality represented by Radio Signal Received Quality (RSRQ), or other measurements that the UE performs on signals from the network entity. In some aspects, the measurements may be L1 measurements such as one or more of an RSRP, an RSRQ, a received signal strength indicator (RSSI), or a signal to noise and interference ratio (SINR) measurement of various signals, such as a SSB, a PSS, an SSS, a broadcast channel (BCH), a DM-RS, CSI-RS, or the like.

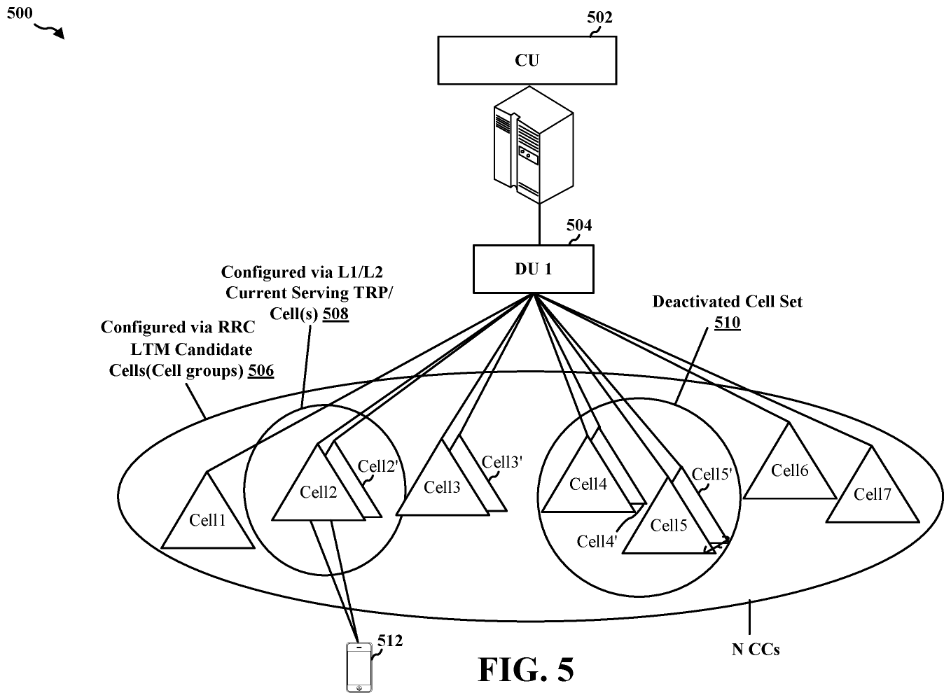

In some aspects, all cells in the LTM configured cell set may belong to a same DU and the cells may be on a same or different carrier frequencies. Cells in the LTM configured cell set may cover a mobility area. FIG. 5 is a diagram 500 illustrating example cell configuration. As illustrated in FIG. 5, a CU 502 (which may correspond to a component of a network entity such as a gNB) may be associated with a first DU 504 (and other DUs). An LTM configured cell set 506 may be associated with the first DU 504 and may include an LTM activated cell set 508 and an LTM deactivated cell set 510. The LTM configured cell set 506 may also include one or more cells not in the current LTM activated cell set 508 or the current LTM deactivated cell set 510. For example, at a given time, the LTM activated cell set 508 may include a first subset of the LTM configured cell set, and the LTM deactivated cell set 510 may include a second, non-overlapping subset of the LTM configured cell set. There may remain one or more cells that are in the LTM configured cell set that are not in the first set subset (e.g., activated) or the second subset (e.g., deactivated). A UE 512 may use the cells in the LTM activated cell set 508 for data channel and control channel communications.

A UE may be provided with a subset of LTM deactivated cells (candidate cell set) that the UE may autonomously choose to add to the LTM activated cell set. For example, the UE may add cells in the subset of LTM deactivated cells to the LTM activated cell set based on measurements (e.g., measured channel quality), loading, or the like. In some aspects, each of the RUs could have multi-component carrier (CC) (N CCs) support (where each CC is a cell). In some aspects, activation or deactivation may be performed for groups of carriers (cells). For PCell management, L1/L2 signaling may be used to set the PCell out of the configured options within the activated cell set. In some aspects, L3 mobility may be used for PCell change (L3 handover) when a new PCell is not from the activated cell set for LTM. As an example, RRC signaling may be used to update the set of cells for LTM at L3 handover. Example aspects may enable L1/L2 based inter-cell mobility that may co-exist with CA. Example aspects may provide configuration, cell activation or deactivation, and associated with signaling to enable LTM with CA to facilitate more efficient and robust mobility management. In some aspects, LTM configured cells may be associated with a PCell configuration without being the PCell. The PCell configuration may be activated and one of the LTM activated cells (e.g., in an LTM activated cell set) may be activated based on L1/L2 signaling to become a PCell. In some aspects, LTM deactivated cells (e.g., in an LTM deactivated cell set) may support L1 measurements to facilitate sufficient beam management, timing synchronization, power control, or the like. For LTM deactivated cells, measurement reporting may be done on an activated cell. In LTM, a special cell (SpCell) (which may be a PCell or a PSCell) change may be done via L2 signaling (e.g., MAC-CE) and enabled by other L1/L2 signaling. The LTM may be configured via RRC and the LTM configuration may be provided to a UE upfront (e.g., before LTM starts). LTM may be network controlled and the source cell of the network may provide or control: (1) L1 measurements and reporting configuration, (2) decision to switch cell(s), (3) enhancements before cell switch such as pre-synchronization, timing advance (TA) handling, target cell beam management, or the like).

An L1 RSRP report may include beam index and RSRP values or differential RSRP values. As an example, in some wireless communication systems, the beam index may be encoded using six or seven bits. Among the reported RSRP values, the strongest RSRP value may be reported using an entry of seven bits (e.g., from −140 to −45 decibel-milliwatts (dBm) with 1 decibel (dB) resolution), and the remaining RSRP values may be reported based on entries of differential RSRP using four bits (e.g., from 0 dBm to −30 dB with 2 dB resolution). As a particular example of L1 measurement report, an LTM L1 measurement report which may be SSB based L1 measurement report in LTM may include: (1) M times L beams reported in a single report instance, where M represents the quantity of reported beams per cell (e.g., M=1, 2, 3, or 4), and where L represents the quantity of reported cells (e.g., L=1, 2, 3, or 4). A maximum value associated with M and a maximum value associated with L may be jointly or separately configured based on a capability associated with the UE. In some aspects, particular value(s) of M and L may be configured in a reporting configuration associated with the LTM L1 measurement report. In some aspects, a LTM L1 measurement report may have a fixed payload (e.g., the size of the LTM L1 measurement report in bits may be fixed).

As an particular example, all measured cells for the same report have same quantity of measured SSBs per cell, e.g., all four measured cells are on FR2 with 32 measured SSBs per cell, each reported cell may be identified by a 2-bit virtual cell ID, such as the corresponding order ID among all measured cells for the same report. Each reported SSB may be identified by a 5-bit virtual SSB ID, e.g. the corresponding order ID. The measurement report may include a 2-bit virtual ID of a first cell, which may be associated with a 5-bit virtual ID of a first reported SSB associated with the first cell and a 7-bit absolute value of RSRP associated with the first reported SSB associated with the first cell, a 5-bit virtual ID of a second reported SSB associated with the first cell and a 4-bit differential value of RSRP associated with the second reported SSB associated with the first cell, and so on. The measurement report may also include a 2-bit virtual ID of a second cell, which may be associated with a 5-bit virtual ID of a first reported SSB associated with the second cell and a 4-bit differential value of RSRP associated with the first reported SSB associated with the second cell, a 5-bit virtual ID of a second reported SSB associated with the second cell and a 4-bit differential value of RSRP associated with the second reported SSB associated with the second cell, and so on.

As another particular example, some measured cells for the same measurement report may have different quantity of measured SSBs per cell, such as two cells are on FR2 with 32 measured SSBs per cell, while another two cells are on FRI with four measured SSBs per cell. In such an example, the virtual SSB ID may be 5 bits for FR2 cells, and 2 bits for FRI cells. The measurement report may include a 2-bit virtual ID of a first cell (with 32 SSBs), which may be associated with a 5-bit virtual ID of a first reported SSB associated with the first cell and a 7-bit absolute value of RSRP associated with the first reported SSB associated with the first cell, a 5-bit virtual ID of a second reported SSB associated with the first cell and a 4-bit differential value of RSRP associated with the second reported SSB associated with the first cell, and so on. The measurement report may also include a 2-bit virtual ID of a second cell, which may be associated with a 2-bit virtual ID of a first reported SSB associated with the second cell and a 4-bit differential value of RSRP associated with the first reported SSB associated with the second cell, a 2-bit virtual ID of a second reported SSB associated with the second cell and a 4-bit differential value of RSRP associated with the second reported SSB associated with the second cell, and so on. Because the size of the virtual ID for each SSB associated with the second cell is smaller than the size of the virtual ID for each SSB associated with the first cell by 3-bits, entries associated with each SSB associated with the second cell may also include a 3-bit padding to make the entries uniform.

In some aspects, a table of combinations of a quantity of K chosen RSs from a quantity of N RSs may be defined. Instead of using individual RS index, a measurement report may report the index of the selected combination of RSs in the table. There may be a total of C(N, K) different combinations. For example, if N=10 and K=4, there may be 210 different combinations of choosing 4 RSs out of 10 RSs. Therefore, to indicate a particular combination, an entry of 8 bits (equal to ceiling (log₂ 210)) may be used. The network entity and the UE may share the same table of combinations either by using a configured table or generate the same table based on a same rule. An example method of generating the table of combinations may include a first step of: For each N choose K combinations, first sort the K choosing indices in a particular order (ascending or descending) order, then order all combinations lexicographically. For example, for N=6 and K=3, there are 20 choices. They are ordered as (0,1,2), (0,1,3), (0,1,4), (0,1,5), (0,2,3), (0,2,4), (0,2.5), (0,3,4), (0,3,5). (0,4,5), (1,2,3), (1,2,4), (1,2,5), (1,3,4), (1,3,5), (1,4,5), (2,3,4), (2,3,5), (2,4,5), (3,4,5).

The example method of generating the table of combinations may include a second step of using the following to order the combinations: for each choices of N choose K combinations, first sort the K choosing indices in ascending order. Then order all combinations lexicographically. Let the N items be 0, 1 . . . . N−1.

The example method of generating the table of combinations may include a third step of using an algorithm to find the index of a specific combination (a_1, a_2, . . . , a_K), in which a 1<a_2< . . . <a_K<=N−1. The number of combinations starting with 0, 1, . . . a_1−1 is x_1. x_1=C(N−1, K−1)+C(N−2, K−1)+C (N−3, K−1)+ . . . . C(K−1, K−1) (define C(i,j)=0 if i<j). The number of combinations with first position a_1, second position a_1+1, a_1+2, . . . a_2−1, is x_2. x_2=C(N−a_1−1, K−2)+C(N−a_1−2, K−2), + . . . +C(K−2, K−2). Such computation may continue until max (0, a_K)−1. The number of combinations with the first K−1 positions as (a_1, a_2, . . . , a_(K−1)) and the kth position 0, 1, . . . , a_K−1, is max (0, a_K). The index of a specific combination (a_1, a_2, . . . a_K) is: x_1+x_2+ . . . +max (0, a_K)−1.

The example method of generating the table of combinations may include a fourth step of using an algorithm to decode the combination from the received index of a combination. First, find a_1 such that the number of combinations with first position 0, 1, . . . a_1−1<index<=the number of combinations with first position 0, 1, . . . a_1. Second, find a_2 such that the number of combinations with first position a_1, second position a1+1, a_1+2, . . . , a_2−1<index<the number of combinations with first position a_1, second position a1+1, a_1+2, . . . , a_2. Such procedure may continue until all a_1, a_2, . . . a_K are identified.

Aspects provided herein may enable use combinations to encode the cell selection and use combinations to encode the reported SSB index for each reported cell so that the size of the measurement report may be reduced, reducing signaling overhead in the wireless communication system and improving efficiency.

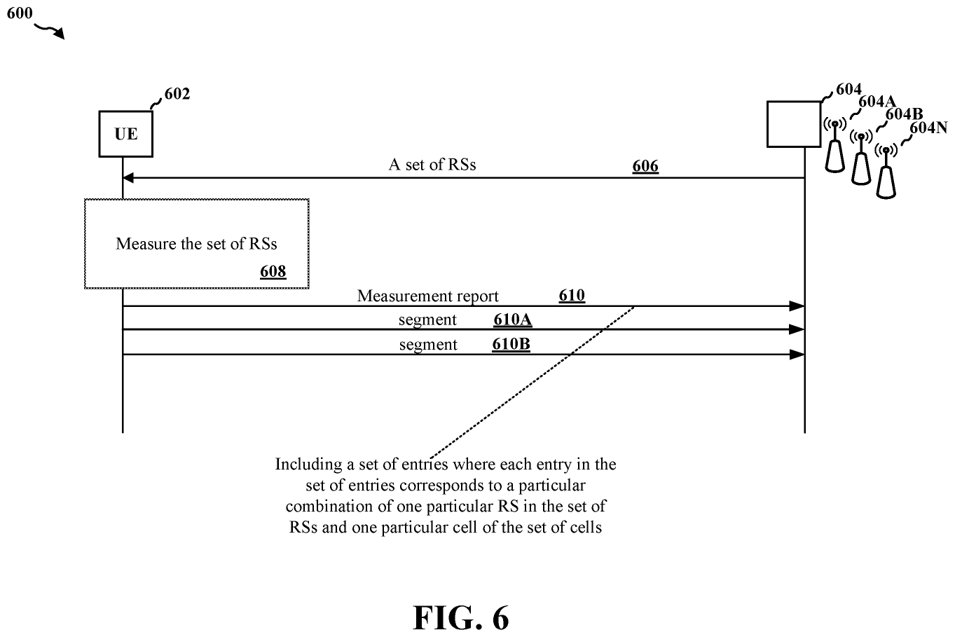

FIG. 6 is a diagram 600 illustrating example communications between a network entity 604 and a UE 602, in accordance with various aspects of the present disclosure. As illustrated in FIG. 6, the network entity 604 may be associated with one or more cells including a first cell 604A, a second cell 604B, and a third cell 604N. The network entity 604 may transmit a set of RSs 606, which may be received by the UE 602, to facilitate various measurements at different UEs including the UE 602. In some aspects, the set of RSs 606 may be SSBs associated with an LTM. In some aspects, the set of RSs 606 may be associated with the set of cells. For example, a first subset of the set of RSs 606 may be associated with (e.g., transmitted by and correspond to a particular beam of) the first cell 604A, a second subset of the set of RSs 606 may be associated with (e.g., transmitted by and correspond to a particular beam of) the second cell 604B, a third subset of the set of RSs 606 may be associated with (e.g., transmitted by and correspond to a particular beam of) the third cell 604N, or the like.

Upon receiving the set of RSs 606, at 608, the UE 602 may measure the set of RSs with respect to one or more metrics, such as RSRP, RSSI, SINR, RSRQ, or the like. After measuring the set of RSs 606, the UE 602 may transmit a measurement report 610 to the network entity 604 to report information with respect to the set of RSs. The information being reported in the measurement report 610 may include (1) one or more best performing RSs for the one or more cells, including the first cell 604A, the second cell 604B, the third cell 604N, or the like, (2) specific values of the metrics which may be represented in actual values or differential values relative to a base value, (3) an index associated with the particular RS(s) (of the set of RSs 606) that may be associated with particular cell(s) (such as an index of each particular combination of RS and cell), or the like. In some aspects, the measurement report 610 may include a set of entries where each entry corresponds to a combination of RS and cell and may be one or more bits.

As a comparison, if the network entity configures 4 cells to measure, and there are 32 beams in each cell. For case of M=2, 3, 4 and L=1, 2, 3, 4, tables 2 and 3 show the number of bits used for method 1 of using index for RS index and method 2 of using combinations of RS index and cell index:

TABLE 2
Comparison of using combination or not for measurement report

| | (1, 2) | (1, 3) | (1, 4) | (2, 2) | (2, 3) | (2, 4) |
|---|---|---|---|---|---|---|
| Method 1 | 23 | 30 | 39 | 43 | 61 | 79 |
| Method 2 | 21 | 30 | 37 | 42 | 59 | 73 |

TABLE 3
Comparison of using combination or not for measurement report

| | (3, 2) | (3, 3) | (3, 4) | (4, 2) | (4, 3) | (4, 4) |
|---|---|---|---|---|---|---|
| Method 1 | 64 | 91 | 118 | 77 | 113 | 149 |
| Method 2 | 59 | 84 | 104 | 75 | 107 | 135 |

In some aspects, the UE 602 may UE measure on M cells. If the total RS measured across the M cell is N, and UE 602 may report K RS measurement result to the network entity 604 in the measurement report 610. For example, the K RS with highest RSRP among all measured beams across M cells may be reported. In some aspects, if the network entity 604 does not know how many reported RSs are from each cell, then the RS index may also include ceil (log 2(M)) bits to indicate the cell it belongs to. In some aspects, in case of number of measured RSs are different across the cells, extra padding may be used for the RS index to maintain a fixed report length. For example, M=4, and 2 cells have 32 RSs to be measured and the other 2 cells have 8 RSs to be measured, each RS may be reported based on an entry of log 2(4)+log 2(32)=7 bits. In some aspects, the UE 602 may concatenate all the measured RS from all cells and use combinations to encode the selected RSs' indices. For example, when M=4, and 2 cells have 32 RSs to be measured and the other 2 cells have 8 RSs to be measured, the total RS may be 80 (2 times 32 equal to 64, plus 2 times 8 equal to 16, which equal to 80), and may use an entry of size ceil (log 2(80))=7 bits for each RS.

Referring back to FIG. 6, in some aspects, the measurement report 610 may be transmitted in a single PUCCH resource. In some aspects, the measurement report 610 may be too large to be transmitted in a single PUCCH resource. In such cases, in some aspects, medium access control (MAC) control element (MAC-CE) may be used to by the UE 602 to carry the measurement report 610 when the payload size is larger than a configured threshold (e.g., configured based on signaling from network entity 604 or without signaling). In some aspects, the measurement report 610 may be divided into different segments via UCI. For example, if the payload size associated with the measurement report 610 is larger than a threshold, the UE 602 may split the measurement into two segments (e.g., 610A and 610B) and report each segment in respective UCI. In some aspects, the UE 602 may put the RSs index and its differential RSRP value together, and segment along a RS report boundary. In such aspects, the report in one segment does not depend on the report on other segments. In some aspects, the UE 602 may put all RSs index together, and all differential RSRP value together, and segment along RS index or differential RSRP value boundary. In such aspects, the report in one segment may depend on the report on other segments. For example, when using bitmap plus differential value report format, if the UE 602 divide the whole report to bitmap segment and differential value segment, and if one segment is lost, then the measurement report 610 cannot be reconstructed in its entirety at the network entity 604.

The following tables provide example structures of measurement report and example sizes of entries of different M and L based on cell and SSB or based on combination of SSB, where M represents the quantity of reported beams per cell (e.g., M=1, 2, 3, or 4), and where L represents the quantity of reported cells (e.g., L=1, 2, 3, or 4).

### For L=1, M=2:

TABLE 4
Example structure of measurement report
2-bit virtual ID of reported cell

| | |
|---|---|
| 5-bit virtual ID of 1^{st} reported SSB | 7-bit absolute RSRP |
| 5 bit virtual ID of 2^{nd} reported SSB | 4-bit differential RSRP |

TABLE 5
Example structure of measurement report
2-bit virtual ID of reported cell

| | |
|---|---|
| 9 bit of combination order of C(32, 2) | 7-bit absolute RSRP |
| 1 bit indicate which of 2 beam is the | 4-bit differential RSRP |
| best RSRP | |

### For L=1, M=2:

TABLE 6
Example structure of measurement report
2-bit virtual ID of reported cell

| | |
|---|---|
| 5-bit virtual ID of 1^{st} reported SSB | 7-bit absolute RSRP |
| 5 bit virtual ID of 2^{nd} reported SSB | 4-bit differential RSRP |
| 5 bit virtual ID of 3rd reported SSB | 4-bit differential RSRP |

TABLE 7
Example structure of measurement report
2-bit virtual ID of reported cell

| | |
|---|---|
| 13 bit of combination order of C(32, 3) | 7-bit absolute RSRP |
| 2 bit indicate which of 3 beam is the | 4-bit differential RSRP |
| best RSRP | 4-bit differential RSRP |

### For L=1, M=2:

TABLE 8
Example structure of measurement report
2-bit virtual ID of reported cell

| | |
|---|---|
| 5-bit virtual ID of 1^{st} reported SSB | 7-bit absolute RSRP |
| 5 bit virtual ID of 2^{nd} reported SSB | 4-bit differential RSRP |
| 5 bit virtual ID of 3rd reported SSB | 4-bit differential RSRP |
| 5 bit virtual ID of 4th reported SSB | 4-bit differential RSRP |

TABLE 9
Example structure of measurement report
2-bit virtual ID of reported cell

| | |
|---|---|
| 16 bit of combination order of C(32, 4) | 7-bit absolute RSRP |
| 2 bit indicate which of 4 beam is the | 4-bit differential RSRP |
| best RSRP | |
| | 4-bit differential RSRP |
| | 4-bit differential RSRP |

### For L=2, M=2:

TABLE 10
Example structure of measurement report
2-bit virtual ID of reported cell

| | |
|---|---|
| 5-bit virtual ID of 1^{st} reported SSB | 7-bit absolute RSRP |
| 5-bit virtual ID of 2nd reported SSB | 4-bit differential RSRP |

2-bit virtual ID of 2^{nd} reported cell

| | |
|---|---|
| 5-bit virtual ID of 1^{st} reported SSB | 4-bit differential RSRP |
| 5-bit virtual ID of 2nd reported SSB | 4-bit differential RSRP |

TABLE 11
Example structure of measurement report

3 bit of combination order of C(4, 2) indicating cell selection
2 bit indicate which of 4 beam is the best RSRP
9 bit of combination order of C(32, 2) of reported RS of first cell
9 bit of combination order of C(32, 2) of reported second cell
7 bit absolute RSRP + 4 * 3 differential RSRP (order consistent
with RS Index order)

### For L=2, M=3:

TABLE 12
Example structure of measurement report

3 bit of combination order of C(4, 2) indicating cell selection
3 bit indicate which of 6 beam is the best RSRP
13 bit of combination order of C(32, 3) of reported RS of first cell
13 bit of combination order of C(32, 3) of reported second cell
7 bit absolute RSRP + 4 * 5 differential RSRP (order consistent
with RS Index order)

### For L=2, M=4:

TABLE 13
Example structure of measurement report

3 bit of combination order of C(4, 2) indicating cell selection
3 bit indicate which of 8 beam is the best RSRP
16 bit of combination order of C(32, 4) of reported RS of first cell
16 bit of combination order of C(32, 4) of reported second cell
7 bit absolute RSRP + 4 * 7 differential RSRP (order consistent
with RS Index order)

### For L=3, M=2:

TABLE 14
Example structure of measurement report
2-bit virtual ID of reported cell

| | |
|---|---|
| 5-bit virtual ID of 1^{st} reported SSB | 7-bit absolute RSRP |
| 5-bit virtual ID of 2nd reported SSB | 4-bit differential RSRP |

2-bit virtual ID of 2^{nd} reported cell

| | |
|---|---|
| 5-bit virtual ID of 1^{st} reported SSB | 4-bit differential RSRP |
| 5-bit virtual ID of 2nd reported SSB | 4-bit differential RSRP |

2-bit virtual ID of 3rd reported cell

| | |
|---|---|
| 5-bit virtual ID of 1^{st} reported SSB | 4-bit differential RSRP |
| 5-bit virtual ID of 2nd reported SSB | 4-bit differential RSRP |

TABLE 15
Example structure of measurement report

2 bit of combination order of C(4, 2) indicating cell selection
3 bit indicate which of 6 beam is the best RSRP
9 bit of combination order of C(32, 3) of reported RS of 1st cell
9 bit of combination order of C(32, 3) of reported RS of 2nd cell
9 bit of combination order of C(32, 2) of reported 3rd cell
7 bit absolute RSRP + 4 * 5 differential RSRP (order consistent
with RS Index order)

### For L=3, M=3:

TABLE 16
Example structure of measurement report

2 bit of combination order of C(4, 2) indicating cell selection
4 bit indicate which of 9 beam is the best RSRP
13 bit of combination order of C(32, 3) of reported RS of 1st cell
13 bit of combination order of C(32, 3) of reported RS of 2nd cell
13 bit of combination order of C(32, 3) of reported 3rd cell
7 bit absolute RSRP + 4 * 8 differential RSRP (order consistent
with RS Index order)

### For L=3, M=4:

TABLE 17
Example structure of measurement report

2 bit of combination order of C(4, 2) indicating cell selection
4 bit indicate which of 9 beam is the best RSRP
16 bit of combination order of C(32, 4) of reported RS of 1st cell
16 bit of combination order of C(32, 4) of reported RS of 2nd cell
16 bit of combination order of C(32, 4) of reported 3rd cell
7 bit absolute RSRP + 4 * 11 differential RSRP (order consistent
with RS Index order)

### For L=4, M=2:

TABLE 18
Example structure of measurement report

2-bit virtual ID of cell with best RSRP
5 * 8 bit virtual ID of reported SSB index
7-bit absolute RSRP + 4 * 7 bit of differential RSRP(order
consistent with RS Index order)

TABLE 19
Example structure of measurement report

3 bit indicate which of 8 beam is the best RSRP
9 * 4 bit of combination order of C(32, 2) of reported RS of each cell
7 bit absolute RSRP + 4 * 7 differential RSRP (order consistent with
RS Index order)

### For L=4, M=3:

TABLE 20
Example structure of measurement report

2-bit virtual ID of cell with best RSRP
5 * 12 bit virtual ID of reported SSB index
7-bit absolute RSRP + 4 * 11 bit of differential RSRP(order
consistent with RS Index order)

TABLE 21
Example structure of measurement report

4 bit indicate which of 12 beam is the best RSRP
13 * 4 bit of combination order of C(32, 3) of reported RS of each cell
7 bit absolute RSRP + 4 * 11 differential RSRP (order consistent with
RS Index order)

### For L=4, M=4:

TABLE 22
Example structure of measurement report

2-bit virtual ID of cell with best RSRP
5 * 16 bit virtual ID of reported SSB index
7-bit absolute RSRP + 4 * 15 bit of differential RSRP(order consistent
with RS Index order)

TABLE 23
Example structure of measurement report

4 bit indicate which of 16 beam is the best RSRP
16 * 4 bit of combination order of C(32, 4) of reported RS of each cell
7 bit absolute RSRP + 4 * 15 differential RSRP (order consistent with
RS Index order)

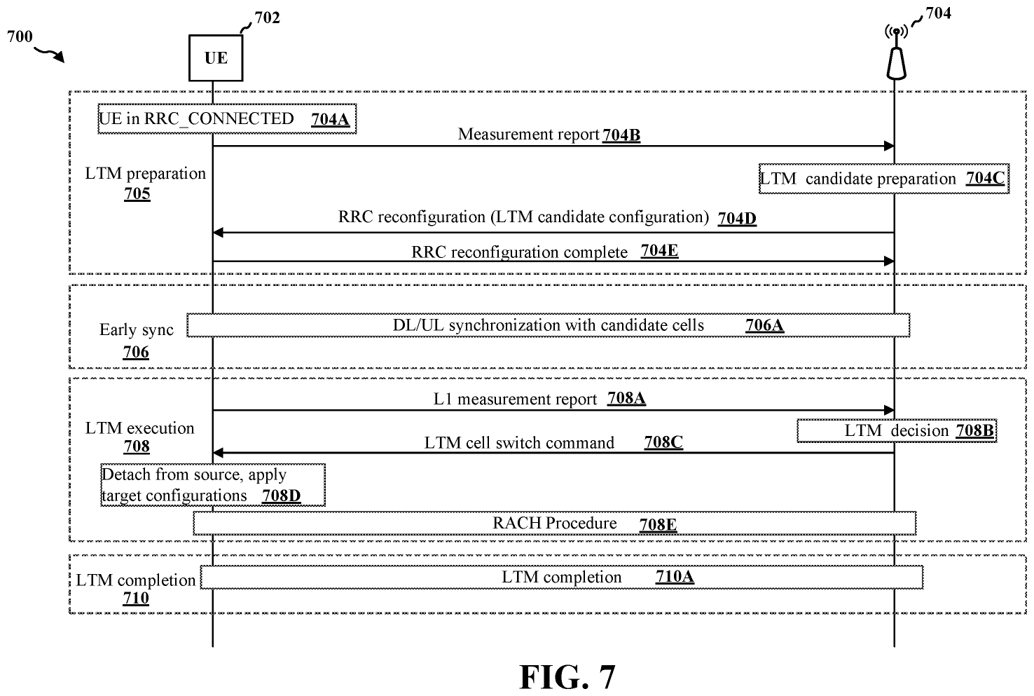

FIG. 7 is a diagram 700 illustrating example communications between a network entity 704 and a UE 702 for LTM or L1/L2 triggered mobility, in accordance with various aspects of the present disclosure. As illustrated in FIG. 7, at 705, the UE 702 and the network entity 704 may prepare for LTM. At 704A, the UE 702 may be in an RRC connected mode, and the UE 702 may transmit a measurement report 704B to the network entity 704. The measurement report 704B may be the measurement report 610 described in connection with FIG. 6 and may include a set of entries where each entry in the set of entries corresponds to a particular combination of one particular RS in the set of RSs and one particular cell of the LTM candidate cells. Based on the measurement report 704B, the network entity 704 may perform an LTM candidate preparation at 704C and identify one or more LTM candidate cells. The network entity 704 may transmit an RRC configuration 704D for LTM to the UE 702. The RRC configuration 704D may include an LTM candidate configuration (e.g., identifying LTM candidate cells) and measurement and reporting configuration (e.g., related to transmitting L1 measurement report for LTM). Upon receiving the RRC configuration 704D, the UE 702 may indicate to the network entity 704 that RRC reconfiguration is complete (e.g., by transmitting an indication 704E).

Once LTM is prepared (e.g., configured), at 706, the UE 702 and the network entity 704 may perform early synchronization. For example, the UE 702 may perform downlink or uplink synchronization with the LTM candidate cells at 706A. In some aspects, based on the measurement and reporting configuration included in the RRC configuration 704D or another configuration, the UE 702 and the network entity 704 may perform LTM execution 708. In some aspects, based on the measurement and reporting configuration included in the RRC configuration 704D or another configuration, the UE 702 may transmit L1 measurement report 708A to the network entity 704, the measurement report 708A may be the measurement report 610 described in connection with FIG. 6 and may include a set of entries where each entry in the set of entries corresponds to a particular combination of one particular RS in the set of RSs and one particular cell of the LTM candidate cells. In some aspects, based on the L1 measurement report 708A from the UE 702, the network entity 704 may perform an LTM decision at 708B to determine whether to trigger LTM for the UE 702. If the network entity 704 determines to trigger LTM for the UE 702 at 708B, the network entity 704 may transmit an LTM cell switch command 708C to the UE 702. The term “LTM cell switch command” may refer to a command (e.g., via MAC-CE) from a network to a UE to trigger the LTM. Upon receiving the LTM cell switch command 708C, the UE 702 may detach from a current source cell and apply configurations for a target cell (e.g., which may be one of a candidate LTM cell included in the LTM candidate configuration) at 708D and perform a RACH procedure 708E with the target cell (e.g., if TA is not available). After performing the RACH procedure 708E, at 710, the LTM may be completed and the UE 702 and the network entity 704 may exchange communication for LTM completion at 710A (e.g., the UE 702 may indicate LTM completion to the network entity 704). The process to detach from a current source cell, apply configurations for a target LTM candidate cell, and connect to the LTM candidate cell may be referred to as “LTM cell switch.”

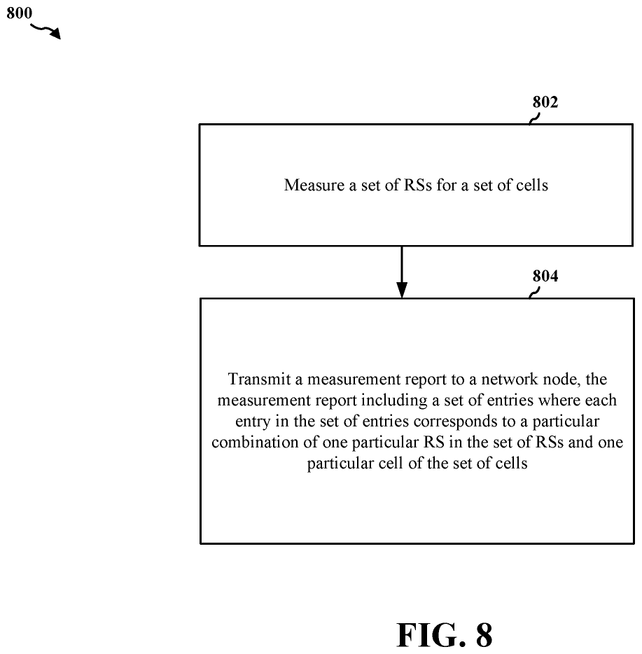

FIG. 8 is a flowchart 800 of a method of wireless communication. The method may be performed by a UE (e.g., the UE 104; the apparatus 1004).

At 802, the UE may measure a set of RSs for a set of cells. For example, the UE 602 may measure (e.g., at 608) a set of RSs (e.g., 606) for a set of cells. In some aspects, 802 may be performed by report component 198.

At 804, the UE may transmit a measurement report to a network node, the measurement report including a set of entries where each entry in the set of entries corresponds to a particular combination of one particular RS in the set of RSs and one particular cell of the set of cells. For example, the UE 602 may transmit a measurement report (e.g., 610) to a network node (e.g., 604), the measurement report including a set of entries where each entry in the set of entries corresponds to a particular combination of one particular RS in the set of RSs and one particular cell of the set of cells. In some aspects, 804 may be performed by report component 198.

In some aspects, the measurement report further includes a second set of entries representing a respective metric associated with each particular combination of the one particular RS in the set of RSs and the one particular cell of the set of cells. In some aspects, the respective metric includes a relative value representing a differential compared to a base value. In some aspects, the measurement report further includes a second set of entries indicating a subset of best performing cells of the set of cells or a set of best performing combinations among each particular combination of the one particular RS in the set of RSs and the one particular cell of the set of cells. In some aspects, the measurement report is included in MAC-CE, and where a payload size associated with the measurement report is larger than a threshold (e.g., the UE would transmit the measurement report in MAC-CE when a payload size associated with the measurement report is larger than a threshold, which may be configured by the network or configured without signaling). In some aspects, the measurement report is included in UCI and the measurement report includes a set of segments, where each segment of the set of segments includes a subset of the set of entries and one or more metrics associated with the subset of the set of entries (e.g., each segment may be independently interpreted). In some aspects, the measurement report is included in UCI and the measurement report includes a set of segments, where a first segment of the set of segments includes the set of entries and a second segment of the set of segments includes one or more metrics associated with the set of entries (e.g., interpreting the second segment or subsequent segment(s) may be based on the first segment because the first segment includes the set of entries that serve as an index). In some aspects, the set of cells corresponds to a set of LTM cells. In some aspects, the measurement report is a LTM measurement report. In some aspects, the set of RSs correspond to a set of SSBs.

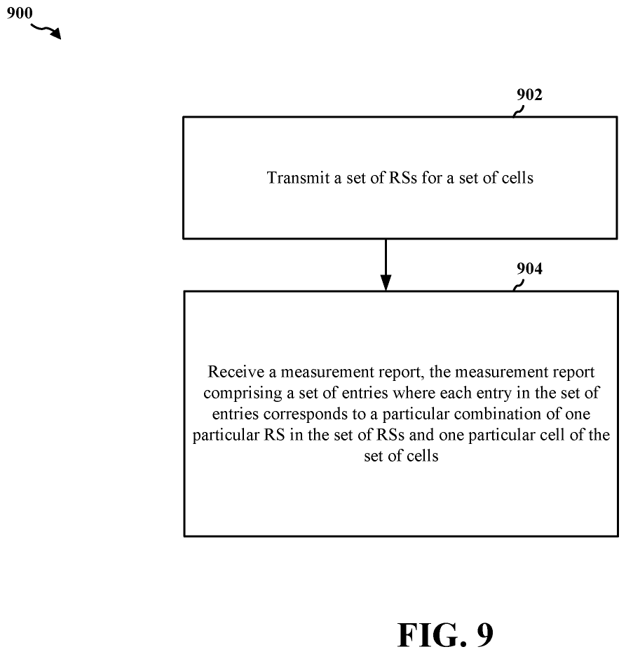

FIG. 9 is a flowchart 900 of a method of wireless communication. The method may be performed by a network entity (e.g., the base station 102, the network entity 1002, the network entity 1102).

At 902, the network entity may transmit a set of RSs for a set of cells. For example, the network entity 604 may transmit a set of RSs (e.g., 606) for a set of cells. In some aspects, 902 may be performed by report component 199.

At 904, the network entity may receive a measurement report, the measurement report including a set of entries where each entry in the set of entries corresponds to a particular combination of one particular RS in the set of RSs and one particular cell of the set of cells. For example, the network entity 604 may receive a measurement report (e.g., 610), the measurement report including a set of entries where each entry in the set of entries corresponds to a particular combination of one particular RS in the set of RSs and one particular cell of the set of cells. In some aspects, 904 may be performed by report component 199.

In some aspects, the measurement report further includes a second set of entries representing a respective metric associated with each particular combination of the one particular RS in the set of RSs and the one particular cell of the set of cells. In some aspects, the respective metric includes a relative value representing a differential compared to a base value. In some aspects, the measurement report further includes a second set of entries indicating a subset of best performing cells of the set of cells or a set of best performing combinations among each particular combination of the one particular RS in the set of RSs and the one particular cell of the set of cells. In some aspects, the measurement report is included in MAC-CE, and where a payload size associated with the measurement report is larger than a threshold (e.g., the UE would transmit the measurement report in MAC-CE when a payload size associated with the measurement report is larger than a threshold, which may be configured by the network or configured without signaling). In some aspects, the measurement report is included in UCI and the measurement report includes a set of segments, where each segment of the set of segments includes a subset of the set of entries and one or more metrics associated with the subset of the set of entries (e.g., each segment may be independently interpreted). In some aspects, the measurement report is included in UCI and the measurement report includes a set of segments, where a first segment of the set of segments includes the set of entries and a second segment of the set of segments includes one or more metrics associated with the set of entries (e.g., interpreting the second segment or subsequent segment(s) may be based on the first segment because the first segment includes the set of entries that serve as an index). In some aspects, the set of cells corresponds to a set of LTM cells. In some aspects, the measurement report is a LTM measurement report. In some aspects, the set of RSs correspond to a set of SSBs.

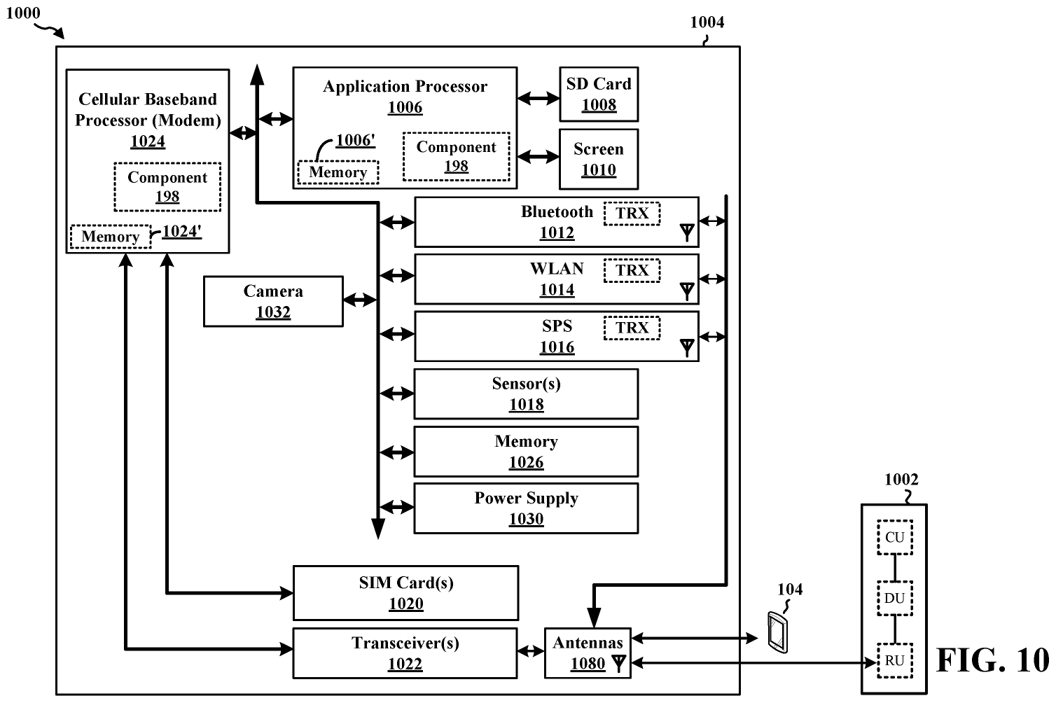

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the report component 198 may be configured to measure a set of RSs for a set of cells. In some aspects, the report component 198 may be further configured to transmit a measurement report to a network node, the measurement report including a set of entries where each entry in the set of entries corresponds to a particular combination of one particular RS in the set of RSs and one particular cell of the set of cells. The report component 198 may be within the cellular baseband processor(s) 1024, the application processor(s) 1006, or both the cellular baseband processor(s) 1024 and the application processor(s) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for measuring a set of RSs for a set of cells. In some aspects, the apparatus 1004 may include means for transmitting a measurement report to a network node, the measurement report including a set of entries where each entry in the set of entries corresponds to a particular combination of one particular RS in the set of RSs and one particular cell of the set of cells. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

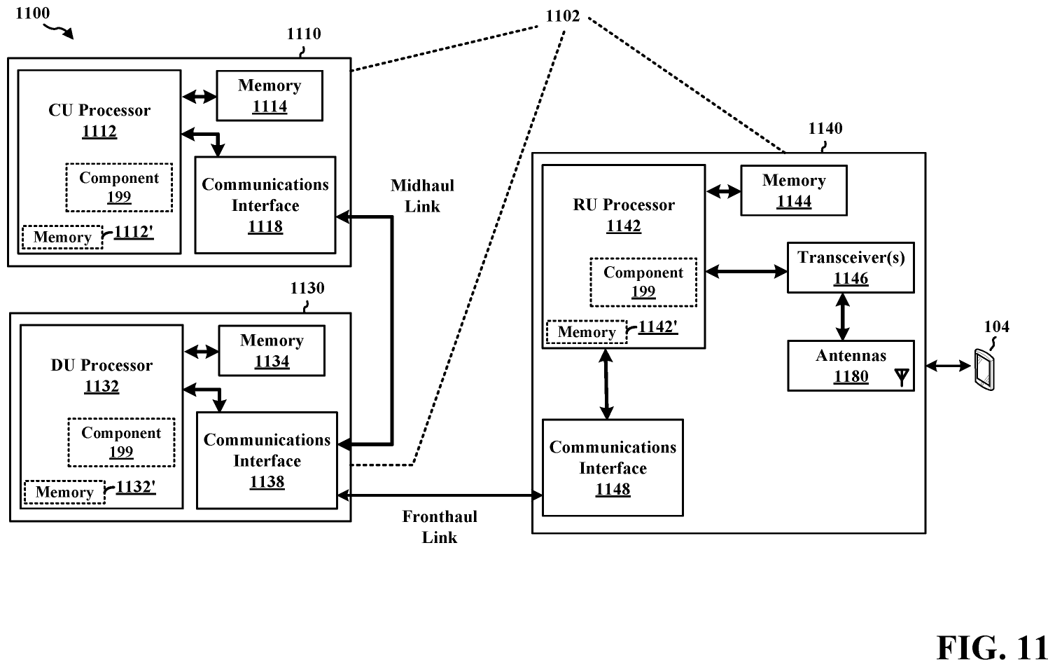

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′. 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the report component 199 may be configured to transmit a set of RSs for a set of cells. In some aspects, the report component 199 may be further configured to receive a measurement report, the measurement report including a set of entries where each entry in the set of entries corresponds to a particular combination of one particular RS in the set of RSs and one particular cell of the set of cells. The report component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for transmitting a set of RSs for a set of cells. In some aspects, the network entity 1102 may include means for receiving a measurement report, the measurement report including a set of entries where each entry in the set of entries corresponds to a particular combination of one particular RS in the set of RSs and one particular cell of the set of cells. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only. A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication performed by a user equipment (UE), including: measuring a set of reference signals (RSs) for a set of cells; and transmitting a measurement report to a network node, the measurement report including a set of entries where each entry in the set of entries corresponds to a particular combination of one particular RS in the set of RSs and one particular cell of the set of cells.

Aspect 2 is the method of aspect 1, where the measurement report further includes a second set of entries representing a respective metric associated with each particular combination of the one particular RS in the set of RSs and the one particular cell of the set of cells.

Aspect 3 is the method of any of aspects 1-2, where the respective metric includes a relative value representing a differential compared to a base value.

Aspect 4 is the method of any of aspects 1-3, where the measurement report further includes a second set of entries indicating a subset of best performing cells of the set of cells or a set of best performing combinations among each particular combination of the one particular RS in the set of RSs and the one particular cell of the set of cells.

Aspect 5 is the method of any of aspects 1-4, where the measurement report is included in medium access control (MAC) control element (MAC-CE), and where a payload size associated with the measurement report is larger than a threshold.

Aspect 6 is the method of any of aspects 1-5, where the measurement report is included in uplink control information (UCI) and the measurement report includes a set of segments, where each segment of the set of segments includes a subset of the set of entries and one or more metrics associated with the subset of the set of entries.

Aspect 7 is the method of any of aspects 1-6, where the measurement report is included in uplink control information (UCI) and the measurement report includes a set of segments, where a first segment of the set of segments includes the set of entries and a second segment of the set of segments includes one or more metrics associated with the set of entries.

Aspect 8 is the method of any of aspects 1-7, where the set of cells corresponds to a set of lower-layer triggered mobility (LTM) cells.

Aspect 9 is the method of aspect 8, where the measurement report is a LTM measurement report.

Aspect 10 is the method of any of aspects 1-9, where the set of RSs correspond to a set of synchronization signal blocks (SSBs).

Aspect 11 is a method for wireless communication performed by a network entity. including: transmitting a set of reference signals (RSs) for a set of cells; and receiving a measurement report, the measurement report including a set of entries where each entry in the set of entries corresponds to a particular combination of one particular RS in the set of RSs and one particular cell of the set of cells.

Aspect 12 is the method of aspect 11, where the measurement report further includes a second set of entries representing a respective metric associated with each particular combination of the one particular RS in the set of RSs and the one particular cell of the set of cells.

Aspect 13 is the method of aspect 12, where the respective metric includes a relative value representing a differential compared to a base value.

Aspect 14 is the method of any of aspects 11-13, where the measurement report further includes a second set of entries indicating a subset of best performing cells of the set of cells or a set of best performing combinations among each particular combination of the one particular RS in the set of RSs and the one particular cell of the set of cells.

Aspect 15 is the method of any of aspects 11-14, where the measurement report is included in medium access control (MAC) control element (MAC-CE), and where a payload size associated with the measurement report is larger than a threshold.

Aspect 16 is the method of any of aspects 11-15, where the measurement report is included in uplink control information (UCI) and the measurement report includes a set of segments, where each segment of the set of segments includes a subset of the set of entries and one or more metrics associated with the subset of the set of entries.

Aspect 17 is the method of any of aspects 11-16, where the measurement report is included in uplink control information (UCI) and the measurement report includes a set of segments, where a first segment of the set of segments includes the set of entries and a second segment of the set of segments includes one or more metrics associated with the set of entries.

Aspect 18 is the method of any of aspects 11-17, where the set of cells corresponds to a set of lower-layer triggered mobility (LTM) cells.

Aspect 19 is the method of aspect 18, where the measurement report is a LTM measurement report.

Aspect 20 is the method of any of aspects 11-19, where the set of RSs correspond to a set of synchronization signal blocks (SSBs).

Aspect 21 is an apparatus for wireless communication at a device including at least one memory and at least one processor coupled to the at least one memory and, the at least one processor, individually or in any combination, based at least in part on information stored in the at least one memory, the at least one processor is configured to implement any of aspects 1 to 10.

Aspect 22 is the apparatus of aspect 21, further including one or more transceivers or one or more antennas coupled to the at least one processor.

Aspect 23 is an apparatus for wireless communication at a device including means for implementing any of aspects 1 to 10.

Aspect 24 is a computer-readable medium (e.g., a non-transitory computer-readable medium) storing computer executable code, where the code when executed by at least one processor causes the at least one processor to implement any of aspects 1 to 10.

Aspect 25 is an apparatus for wireless communication at a device including at least one memory and at least one processor coupled to the at least one memory and, the at least one processor, individually or in any combination, based at least in part on information stored in the at least one memory, the at least one processor is configured to implement any of aspects 11 to 20.

Aspect 26 is the apparatus of aspect 25, further including one or more transceivers or one or more antennas coupled to the at least one processor.

Aspect 27 is an apparatus for wireless communication at a device including means for implementing any of aspects 11 to 20.

Aspect 28 is a computer-readable medium (e.g., a non-transitory computer-readable medium) storing computer executable code, where the code when executed by at least one processor causes the at least one processor to implement any of aspects 11 to 20.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to cause the UE to:
measure a set of reference signals (RSs) for a set of cells; and
transmit a measurement report to a network node, the measurement report comprising a set of entries where each entry in the set of entries corresponds to a particular combination of one particular RS in the set of RSs and one particular cell of the set of cells.

2. The apparatus of claim 1, wherein the measurement report further comprises a second set of entries representing a respective metric associated with each particular combination of the one particular RS in the set of RSs and the one particular cell of the set of cells.

3. The apparatus of claim 2, wherein the respective metric comprises a relative value representing a differential compared to a base value.

4. The apparatus of claim 1, wherein the measurement report further comprises a second set of entries indicating a subset of best performing cells of the set of cells or a set of best performing combinations among each particular combination of the one particular RS in the set of RSs and the one particular cell of the set of cells.

5. The apparatus of claim 1, wherein the measurement report is included in medium access control (MAC) control element (MAC-CE), and wherein a payload size associated with the measurement report is larger than a threshold.

6. The apparatus of claim 1, wherein the measurement report is included in uplink control information (UCI) and the measurement report comprises a set of segments, wherein each segment of the set of segments comprises a subset of the set of entries and one or more metrics associated with the subset of the set of entries.

7. The apparatus of claim 1, wherein the measurement report is included in uplink control information (UCI) and the measurement report comprises a set of segments, wherein a first segment of the set of segments comprises the set of entries and a second segment of the set of segments comprises one or more metrics associated with the set of entries.

8. The apparatus of claim 1, wherein the set of cells corresponds to a set of lower-layer triggered mobility (LTM) cells.

9. The apparatus of claim 8, wherein the measurement report is a LTM measurement report.

10. The apparatus of claim 1, wherein the set of RSs correspond to a set of synchronization signal blocks (SSBs).

11. An apparatus for wireless communication at a network entity, comprising:
at least one memory; and
at least one processor coupled to the at least one memory and, based at least in part on stored information that is stored in the at least one memory, the at least one processor, individually or in any combination, is configured to cause the network entity to:
transmit a set of reference signals (RSs) for a set of cells; and
receive a measurement report, the measurement report comprising a set of entries where each entry in the set of entries corresponds to a particular combination of one particular RS in the set of RSs and one particular cell of the set of cells.

12. The apparatus of claim 11, wherein the measurement report further comprises a second set of entries representing a respective metric associated with each particular combination of the one particular RS in the set of RSs and the one particular cell of the set of cells.

13. The apparatus of claim 12, wherein the respective metric comprises a relative value representing a differential compared to a base value.

14. The apparatus of claim 11, wherein the measurement report further comprises a second set of entries indicating a subset of best performing cells of the set of cells or a set of best performing combinations among each particular combination of the one particular RS in the set of RSs and the one particular cell of the set of cells.

15. The apparatus of claim 11, wherein the measurement report is included in medium access control (MAC) control element (MAC-CE), and wherein a payload size associated with the measurement report is larger than a threshold.

16. The apparatus of claim 11, wherein the measurement report is included in uplink control information (UCI) and the measurement report comprises a set of segments, wherein each segment of the set of segments comprises a subset of the set of entries and one or more metrics associated with the subset of the set of entries.

17. The apparatus of claim 11, wherein the measurement report is included in uplink control information (UCI) and the measurement report comprises a set of segments, wherein a first segment of the set of segments comprises the set of entries and a second segment of the set of segments comprises one or more metrics associated with the set of entries.

18. The apparatus of claim 11, wherein the set of cells corresponds to a set of lower-layer triggered mobility (LTM) cells.

19. The apparatus of claim 18, wherein the measurement report is a LTM measurement report.

20. The apparatus of claim 11, wherein the set of RSs correspond to a set of synchronization signal blocks (SSBs).

21. A method for wireless communication performed by a user equipment (UE), comprising:
measuring a set of reference signals (RSs) for a set of cells; and
transmitting a measurement report to a network node, the measurement report comprising a set of entries where each entry in the set of entries corresponds to a particular combination of one particular RS in the set of RSs and one particular cell of the set of cells.

22. The method of claim 21, wherein the measurement report further comprises a second set of entries representing a respective metric associated with each particular combination of the one particular RS in the set of RSs and the one particular cell of the set of cells.

23. The method of claim 22, wherein the respective metric comprises a relative value representing a differential compared to a base value.

24. The method of claim 21, wherein the measurement report further comprises a second set of entries indicating a subset of best performing cells of the set of cells or a set of best performing combinations among each particular combination of the one particular RS in the set of RSs and the one particular cell of the set of cells.

25. The method of claim 21, wherein the measurement report is included in medium access control (MAC) control element (MAC-CE), and wherein a payload size associated with the measurement report is larger than a threshold.

26. The method of claim 21, wherein the measurement report is included in uplink control information (UCI) and the measurement report comprises a set of segments, wherein each segment of the set of segments comprises a subset of the set of entries and one or more metrics associated with the subset of the set of entries.

27. The method of claim 21, wherein the measurement report is included in uplink control information (UCI) and the measurement report comprises a set of segments, wherein a first segment of the set of segments comprises the set of entries and a second segment of the set of segments comprises one or more metrics associated with the set of entries.

28. The method of claim 21, wherein the set of cells corresponds to a set of lower-layer triggered mobility (LTM) cells.

29. The method of claim 28, wherein the measurement report is a LTM measurement report.

30. A method for wireless communication performed by a network entity, comprising:
transmitting a set of reference signals (RSs) for a set of cells; and
receiving a measurement report, the measurement report comprising a set of entries where each entry in the set of entries corresponds to a particular combination of one particular RS in the set of RSs and one particular cell of the set of cells.
